(19) United States
(12) Patent Application Publication
(10) Pub. No.: US 2016/0378671 A1
(43) Pub. Date: Dec. 29, 2016

(54) CACHE MEMORY SYSTEM AND PROCESSOR SYSTEM

(71) Applicant: KABUSHIKI KAISHA TOSHIBA, Tokyo (JP)

(72) Inventors: Susumu TAKEDA, Kawasaki (JP); Shinobu FUJITA, Tokyo (JP)

(21) Appl. No.: 15/262,635

(22) Filed: Sep. 12, 2016

Related U.S. Application Data
(63) Continuation of application No. PCT/JP2015/058071, filed on Mar. 18, 2015.

(30) Foreign Application Priority Data
Mar. 18, 2014 (JP) 2014-055448

(51) Int. Cl. G06F 12/0886; G06F 12/0897; G06F 12/0842; G06F 12/0804; G06F 12/0811

(52) U.S. Cl. CPC G06F 12/0886; G06F 12/0804; G06F 12/0811; G06F 12/0842; G06F 12/0897; G06F 2212/1024; G06F 2212/1028; G06F 2212/6042; G06F 11/1064

(57) ABSTRACT

A cache memory includes a first cache memory that is accessible per cache line, and a second cache memory that is accessible per word, the second cache memory being positioned in a same cache layer as the first cache memory. It is achieved to improve an average access speed to the first cache memory and also to improve access efficiency because of data access per word, thereby reducing power consumption.

### CROSS REFERENCE TO RELATED APPLICATIONS

This application is based upon and claims the benefit of priority from the prior Japanese Patent Application No. 2014-55448, filed on Mar. 18, 2014, the entire contents of which are incorporated herein by reference.

### FIELD

Embodiments of the present invention relate to a cache memory system and a processor system.

### BACKGROUND

As referred to as a memory wall problem, memory access is a bottleneck in performance and power consumption of processor cores. As a measure against the memory wall problem, there is a tendency for cache memories to have a larger capacity, along with which there is a problem of increase in leakage current of cache memories.

MRAMs that attract attention as a candidate for a large-capacity cache memory are a non-volatile memory, having a feature of much smaller leakage current than SRAMs currently used in cache memories.

However, it is hard to say that the MRAMs are superior to the SRAMs concerning access speed and power consumption. The MRAMs may thus have negative aspects too much in access speed or power consumption depending on programs executed by a processor.

### BRIEF DESCRIPTION OF THE DRAWINGS

FIG. 1 is a block diagram schematically showing the configuration of a processor system 2 having a built-in cache memory 1 according to an embodiment;

FIG. 2 is a block diagram of a detailed internal configuration of the cache memory 1 of FIG. 1;

FIG. 3 is a diagram showing a memory layered structure in the present embodiment;

FIG. 4 is a diagram illustrating the configuration of an L2-cache 7 in the present embodiment;

FIG. 5 is a diagram showing, in detail, an example of the data structure of a second cache memory unit 14;

FIG. 6 is a diagram illustrating the policy of inclusive type (a first policy);

FIG. 7 is a diagram illustrating the policy of Exclusive (a second policy); and FIG. 8 is a diagram illustrating an access-frequency-based word-number variable method.

### DETAILED DESCRIPTION

According to one embodiment, a cache memory includes a first cache memory that is accessible per cache line, and a second cache memory that is accessible per word, the second cache memory being positioned in a same cache layer as the first cache memory.

Hereinafter, embodiments of the present invention will be explained with reference to the drawings. The following embodiments will be explained mainly with unique configurations and operations of a cache memory and a processor system. However, the cache memory and the processor system may have other configurations and operations which will not be described below. These omitted configurations and operations may also be included in the scope of the embodiments.

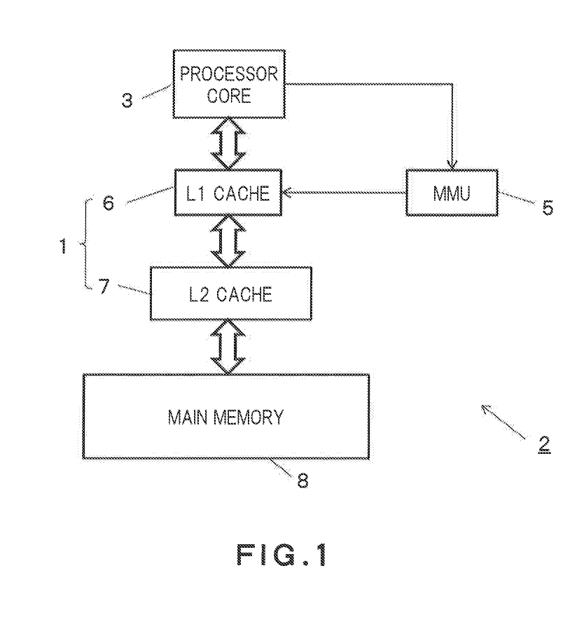

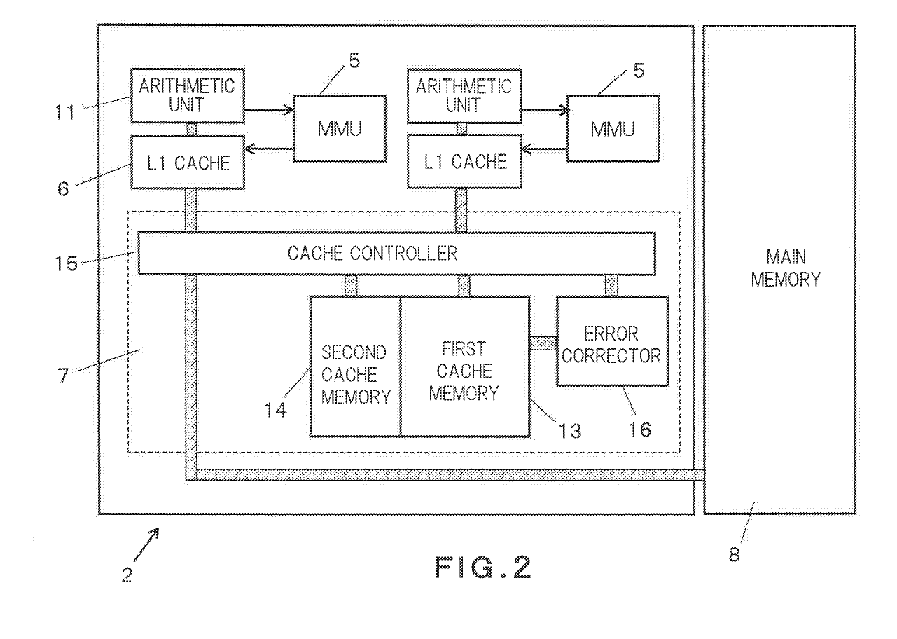

FIG. 1 is a block diagram schematically showing the configuration of a processor system 2 having a built-in cache memory 1 according to an embodiment. The processor system 2 of FIG. 1 is provided with the cache memory 1, a processor core 3, and an MMU 5. The cache memory 1 has a layered structure of, for example, an L1-cache 6 and an L2-cache 7. FIG. 2 is a block diagram of a detailed internal configuration of the cache memory 1 of FIG. 1.

The processor core 3 has, for example, a multicore configuration of a plurality of arithmetic units 11. The L1-cache 5 is connected to each arithmetic unit 11. Since the L1-cache 6 is required to have a high-speed performance, it has an SRAM (Static Random Access Memory), for example. The processor core 3 may have a single-core configuration of one L1-cache 6,

The MMU 5 converts a virtual address issued by the processor core 3 into a physical address to access the main memory 8 and the cache memory 1. The MMU 5 acquires an address of data newly stored in the cache memory 1 and an address of data flushed out from the cache memory 1 to update a conversion table of virtual addresses and physical addresses.

The MMU 5 is usually provided for each arithmetic unit 11. The MMU 5 may be omitted.

The cache memory 1 stores at least a part of data stored in or of data to be stored in the main memory 8. The cache memory 1 includes the L1-cache 6 and cache memories of a level L2 and higher. The present embodiment is explained with an example in which the cache memory 1 has the L1-cache 6 and the L2-cache 6, for brevity.

The L2-cache 6 has a first cache memory unit 13, a second cache memory unit 14, a cache controller 15, and an error corrector 16.

The first cache memory unit 13 is accessible per cache line and is mainly used for storing cache line data. The first cache memory unit 13 is a non-volatile memory such as an MRAM (Magnetoresistive RAM).

The second cache memory unit 14 is a memory, at least a part of which is accessible per word. The second cache memory unit 14 is mainly used for storing tag information of cache line data stored in the first cache memory unit 13 and also storing critical data that is a part of the cache line data. The critical data is any unit of data to be used by the arithmetic units 11 in arithmetic operations. The critical data is, for example, word data. The word data has, for example, 32 bits for a 32-bit arithmetic unit and 64 bits for a 64-bit arithmetic unit. The second cache memory unit 14 is a volatile memory such as an SRAM.

The first cache memory unit 13 and the second cache memory unit 14 may not necessarily be an MRAM and SRAM, respectively. However, the second cache memory unit 14 has at least one of the features of being accessible at a lower power than the first cache memory unit 13 and of being accessible at a higher speed than the first cache memory unit 13.

When the first cache memory unit 13 is an MRAM, the second cache memory unit 14 may be a DRAM or the like. The first cache memory unit 13 and the second cache memory unit 14 may be a pair of a ReRAM (Resistance RAM) and an SRAM respectively, a ReRAM and an MRAM respectively, a PRAM (Phase change RAM) and an SRAM respectively, or a PRAM (Phase Change RAM) and an MRAM respectively.

The cache controller 15 controls access to the first cache memory unit 13 and the second cache memory unit 14. The error corrector 16 corrects an error of the cache memory unit 13. The error corrector 16 generates and stores redundant bits for correcting errors of data to be stored in the first cache memory unit 13 per cache line. The cache controller 15 may have a power control function for the memories and logic circuits it manages. For example, the cache controller 15 may have a function of lowering the power supplied to the second cache memory unit 14 or halting the power supply thereto.

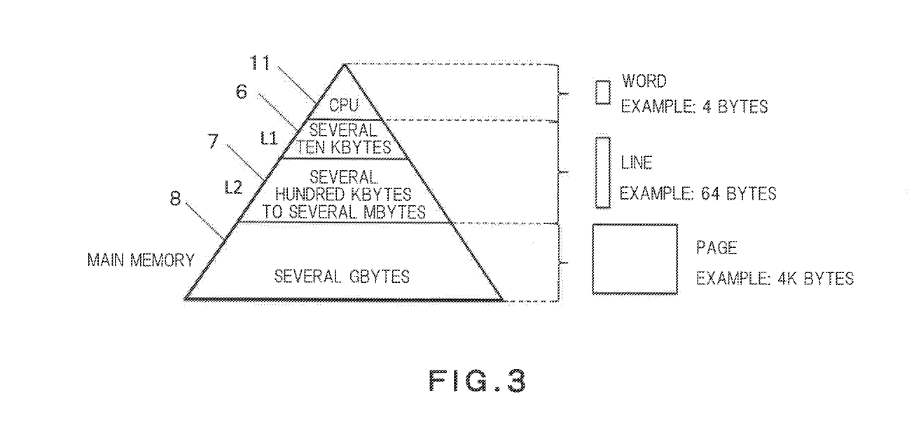

FIG. 3 is a diagram showing a memory layered structure in the present embodiment. As shown, the L1-cache 6 is positioned on the upper-most layer, followed by the L2-cache 7 on the next layer and the main memory 8 on the lower-most layer. When a processor core (CPU) 11 (the arithmetic units 11 in FIG, 2) issues an address, the L1-cache 6 is accessed at first. When there is no hit in the L1-cache 6, the L2-cache 7 is accessed next. When there is no hit in the L2-cache 7, the main memory 8 is accessed. As described above, a higher-level cache memory 1 of an L3-cache or more may be provided, however, what is explained as an example in the present embodiment is the cache memory 1 of the L1-cache 6 and the L2-cache 7 in two layers.

The L1-cache 6 has a memory capacity of, for example, several ten kbytes. The L2-cache 7 has a memory capacity of, for example, several hundred kbytes to several Mbytes. The main memory 8 has a memory capacity of, for example, several Gbytes. The L1-cache 6 and the L2-cache 7 usually store data per cache line. The main memory 8 stores data per page. A cache line has, for example, 64 bytes. One page has, for example, 4 kbytes. The number of bytes for the cache line and the page is arbitrary.

Data that is stored in the L1-cache 6 is also usually stored in the L2-cache 7. Data that is stored in the L2-cache 7 is also usually stored in the main memory 8. There are a variety of variations in data allocation policy to the L1-cache 6 and the L2-cache 7. One variation is, for example, an inclusion type. In this case, all the data stored in the L1-cache 6 are stored in the L2-cache 7.

Another data allocation policy is, for example, an exclusion type. In this mode, for example, no identical data are allocated to the L1-cache 6 and the L2-cache 7. Still, another data allocation policy is, for example, a hybrid of the inclusion type and the exclusion type. In this mode, for example, there are duplicate data to be stored in both of the L1-cache 6 and the L2-cache 7, and data to be exclusively stored in the L1-cache 6 or the L2-cache 7.

These modes are a data allocation policy between the L1- and L2-caches 6 and 7. There are a variety of combinations of modes for a multi-layered cache. For example, the inclusion type may be used for all layers. For example, one option of the combination is the exclusive type between the L1- and L2-caches 6 and 7, and the inclusion type between the L2-cache 7 and the main memory 10. The method shown in the present embodiment can be combined with the above-mentioned variety of data allocation policies.

In the present embodiment, as described below, the L2-cache 7 which usually stores data per cache line can also store data per word. Moreover, when data are stored in the L2-cache 7 per word, they are stored in the second cache memory unit 14 accessible at a high speed.

An example shown in the present embodiment is the L2-cache 7 that is provided with the first cache memory unit 13 accessible per cache line and the second cache memory unit 14 accessible per word, which is positioned in the same cache layer as the first cache memory unit 13. However, the present embodiment is not limited to this example. For example, the L1-cache 6 or a higher-level cache memory of L3 or more may be provided with the first and second cache memory units 13 and 14.

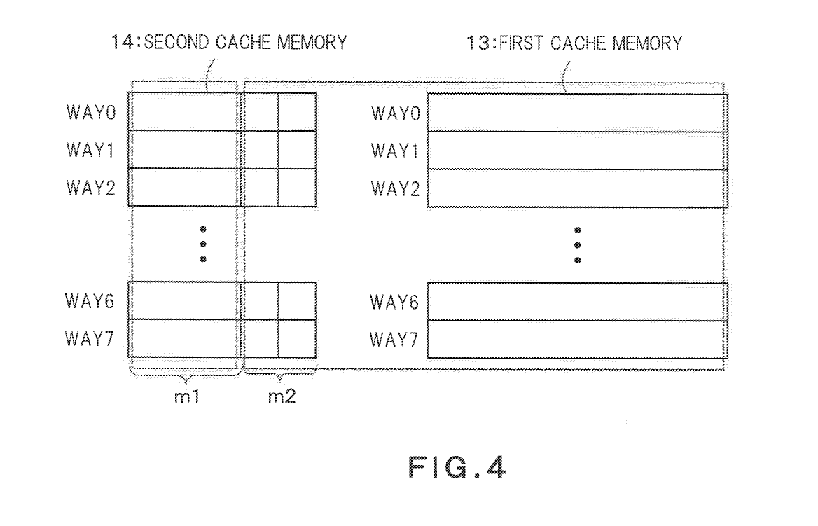

FIG, 4 is a diagram illustrating the configuration of the L2-cache 7 in the present embodiment. As shown in FIG. 4, the first cache memory unit 13 having MRAMs is mainly used as a data array. The data array of FIG. 4 is divided into a plurality of ways 0 to 7, each of which is accessed per cache line. The number of ways is not limited to eight. Moreover, the data array may not have to be divided into a plurality of ways.

The second cache memory unit 14 has a memory area (a first tag) m1 to be used as a tag array and also has a memory area m2 to be used as a part of a data array. Address information, namely, tag information, which corresponds to cache line data to be stored in the data array, is stored in the memory area m1, Data (critical data, hereinafter), which is a part of cache line data stored in the first cache memory unit 13, is stored in the memory area m2. In the present embodiment, the critical data is word data (critical word), for simplicity. The memory area m2 provided in the example of FIG. 4 can store two word data for each way. However, the number of critical data to be stored in the memory area m2 is arbitrary.

There is a reason why a part of lines stored in the first cache memory unit 13 is stored in the second cache memory unit 14 that is accessible at a higher speed than the first cache memory unit 13. The reason is to reduce the decrease in computational efficiency due to MRAMs' disadvantageous low-speed and high-power-consuming accessibility. The computational efficiency is, for example, power consumption per performance. In more specifically, for example, an average access speed is improved by storing word data, which is often accessed first in a cache line, in the second cache memory unit 14. Moreover, necessary data only is accessed by data accessing per word that is a small unit of data for accessing. In this way, unnecessary data accessing is not performed, so that power consumption can be reduced.

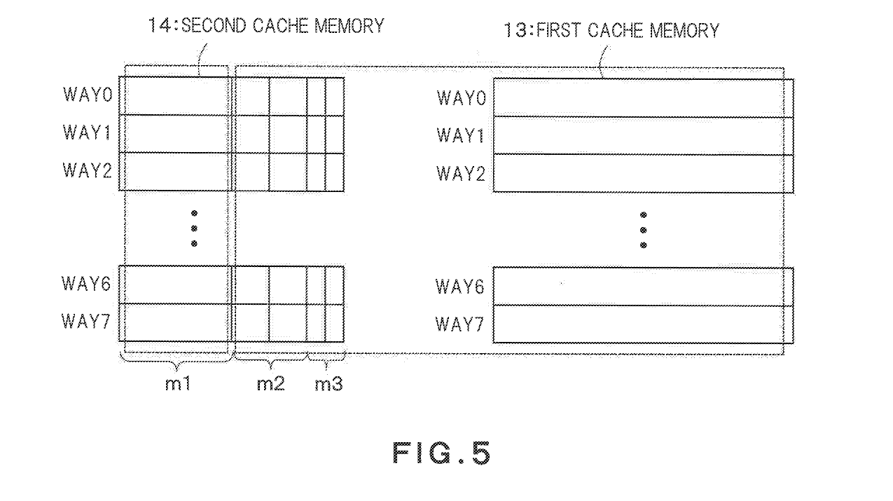

FIG. 5 is a diagram showing, in detail, an example of the data structure of the second cache memory unit 14. As shown, the second cache memory unit 14 has a memory area (a first tag) m1 to be used as a tag array, a memory area m2 to be used as a part of a data array, and a memory area (a second tag) m3 for storing tag information that identifies each data stored in the memory area m2. The tag information to be stored in the memory area m3 may be any information, as long as stored word can be uniquely identified with this tag information only, or with this tag information stored in the memory area m3 and tag information stored in the memory area m1. The memory areas m1 to m3 are in one-to-one correspondence.

It is supposed that one word has 8 bytes and one cache line has 64 bytes. In this case, eight words are stored in one cache line. When storing address information in the memory area m3, at least three bits are required for determining which word data in one cache line has been stored in the memory area m2. Therefore, the memory area m3 requires a memory capacity, at least, for the number of word data to be stored in the second cache memory unit 14, multiplied by three bits.

It is supposed that a word, which is apart from the head word by a given number of words among the eight words in a cache line, is stored in the memory area m3. In this case, three bits are required for each word in order to express which word is stored in the memory area m3, among the eight words.

It is supposed that a bit vector is stored in the memory area m3. In this case, one bit is assigned to each of the eight words, and hence eight bits are required. For example, the first bit is assigned to the head word of a cache line, followed by the second bit to the second word next to the head word. For example, a bit corresponding to a word stored in the second cache memory unit 14 is set to 1, with a bit corresponding to a word not stored therein to 0.

There are two policies on storing word data in the second cache memory unit 14, as follows. In a policy of the inclusive type, word data that is stored in the second cache memory unit 14 is also stored in the first cache memory unit 13, as duplicate data. In a policy of the exclusive type, word data that is stored in the second cache memory unit 14 is not stored in the first cache memory unit 13, as duplicate data.

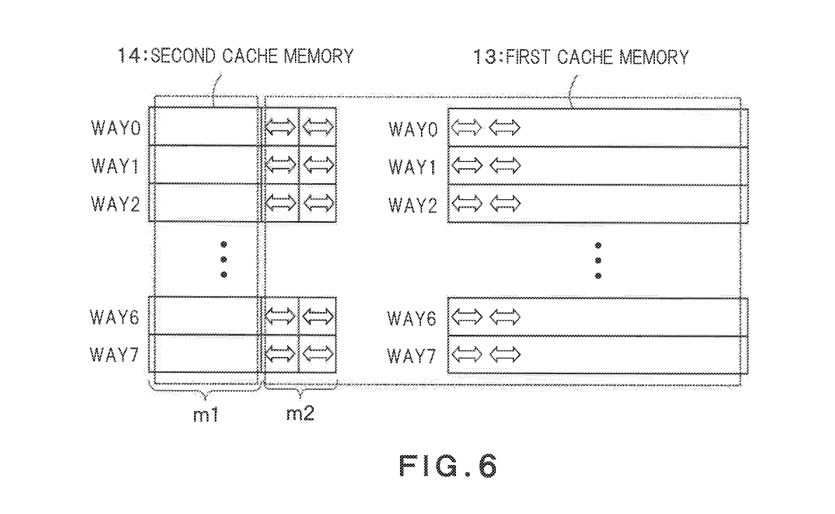

FIG. 6 is a diagram illustrating the policy of the inclusive type (a first policy). In the policy of the inclusive type, word data, which is a part of cache line data stored in the first cache memory unit 13 per cache line, is stored in the memory area m2 of the second cache memory unit 14, as duplicate data. When it is found, with tag information of the L2-cache 7, that word data to be accessed has been stored in the memory area m2, the cache controller 15 accesses the word data stored in the memory area m2, in parallel with accessing the first cache memory unit 13.

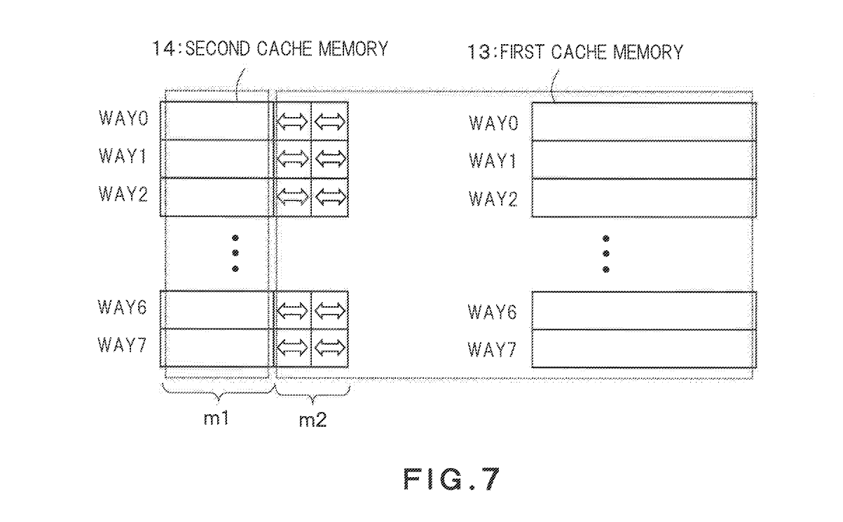

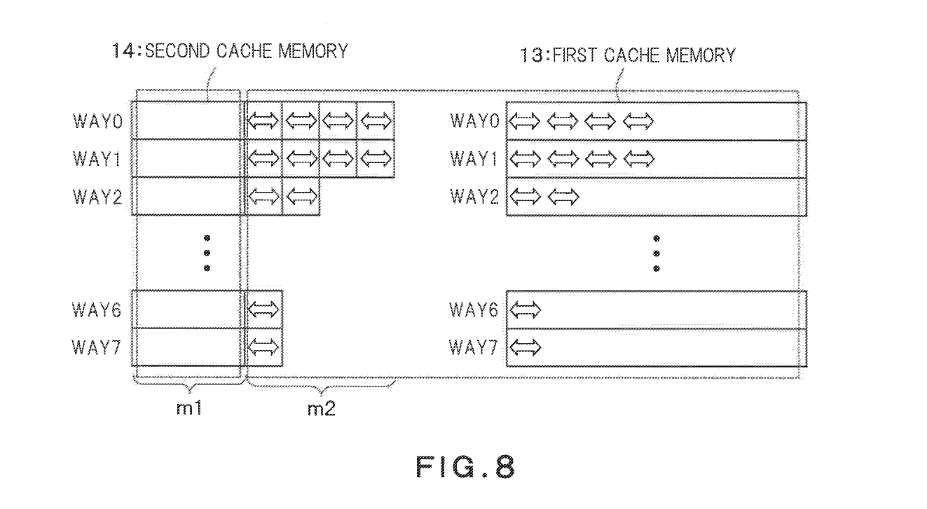

In FIG. 6, although the memory area m3 is omitted, in the same way as shown in FIG. 5, the memory area m3 may be provided to store identification information on word data stored in the memory area m2. Moreover, although the memory area m3 is also omitted from FIGS. 7 and 8 which will be explained later, the memory area m3 may be provided.

FIG. 7 is a diagram illustrating the policy of the exclusive type (a second policy). In the policy of the exclusive type, after word data, which is a part of cache line data stored in the first cache memory unit 13 per cache line, is stored in the memory area m2 of the second cache memory unit 14, this word data is deleted from the first cache memory unit 13. In this way, data is exclusively stored in the first and second cache memory units 13 and 14. Accordingly, the memory areas in the first cache memory unit 13 can be effectively utilized.

In the inclusive type of FIG. 6 and also in the exclusive type of FIG. 7, when the first cache memory unit 13 is divided into a plurality of ways, the same number of word data for each way may be stored in the memory area m2 of the second cache memory unit 14. In contrast, another method which may also be adopted is to prioritize the ways according to the access frequency so that a larger number of word data are stored in the memory area m2 of the second cache memory unit 14 in descending order of priority (an access-frequency-based word-number variable method, hereinafter).

FIG. 8 is a diagram illustrating the access-frequency-based word-number variable method. The cache controller 15 manages access temporal locality with an LRU (Least Recently Used) position. By using the LRU position, the number of word data to be stored in the memory area m2 of the second cache memory unit 14 may be varied for the respective ways in the first cache memory unit 13. In the example of FIG. 8, word data are stored in the memory area m2 of the second cache memory unit 14 in such a manner that four word data are stored in each of the ways 0 and 1, two word data are stored in the way 2, and one word data is stored in each of the ways 6 and 7.

In the access-frequency-based word-number variable method of FIG. 8, the ways are prioritized under consideration of the following two factors.

1) It is highly likely that the way 1 is more frequently accessed than the way 7 in a program, in which there is typical temporal locality, to be executed by a processor core.

2) Prediction is used for identification of important word data, or critical word, and hence a prediction error occurs depending on the situations. Therefore, the larger the number of words to be stored, the more the prediction accuracy may be improved.

What is illustrated in FIG. 8 uses the characteristics in 1) in order to acquire the effect in 2). Under consideration of the above 1) and 2), in FIG. 8, a larger number of word data are stored in the memory area m2 of the second cache memory unit 14, for a way assigned a smaller number.

There are, for example, three methods for identifying a critical word, such as the following first to third methods.

The first method is based on the order of address. An address closer to the head in a cache line tends to be accessed first by a processor core. Therefore, in the first method, word data closer to the head in a cache line is stored in the memory area m2 of the second cache memory unit 14, for each way of the first cache memory unit 13. It is easy in the first method to determine word data to be stored in the memory area m2. The cache controller 15 stores word data one by one in the memory area m2, for a certain number of words from the head address in each cache line. When the first method is used, since there is no necessity of dynamically determining critical word, different from that shown in FIG. 4, the second cache memory unit 14 may not be provided with the memory area m3.

The second method is to prioritize the word data accessed last time. The cache controller 15 uses temporal locality of word data stored in the first cache memory unit 13 to store word data in the memory area m2 in order from the most-recently accessed word data.

The third method is to prioritize more-frequently accessed word data, using the tendency to access word data, at higher frequency, which has been accessed more frequently. The cache controller 15 measures the number of times of accessing for each word data to store word data in the memory area m2 in order from the most-frequently accessed word data. There are a variety of read requests to the cache controller 15. Typical ones are a request using a line address with which line data can be uniquely identified and a request using a word address with which word data can be uniquely identified. For example, accessing using a word address is achieved with any of the first, second and third methods. Accessing using a line address is achieved with the first method.

In the present embodiment, the L1-cache 6 is a read requester and also a write requester. The cache controller 15 of the L2-cache 7 sends read data one by one to the L1-cache 6 which is the read requester. If data for which the arithmetic unit 11 has made a read request is included in the data sent from the L2-cache, the L1-cache sends the requested data to the arithmetic unit 11.

A process of reading from the L2-cache 7 according to the present embodiment will be explained. In general, there are two processes for accessing a tag and data of the L2-cache 7, as follows. One process is parallel access for accessing the tag and data in parallel. The other process is sequential access for accessing the tag and data sequentially.

In addition to the two accessing methods, there is an option of whether to access the memory area m2 of the second cache memory unit 14 and access the first cache memory unit 13, in parallel or sequentially, in the present embodiment. Accordingly, in the present embodiment, for example, there are three methods for the reading process as the combination of the above methods.

1) Parallel accessing to tags of the memory areas m1 and m3 of the second cache memory unit 14, to the memory area m2 of the second cache memory unit 14, and to the first cache memory unit 13.

2) Accessing to the memory areas m1 and m3 of the second cache memory unit 14, and then to the memory area m2 thereof, and then further to the first cache memory unit 13. In this method, firstly, access is made to tags of the memory areas m1 and m3 of the second cache memory unit 14. As a result, if it is found that there is word data present in the memory area m2, access is made to the memory area m2 and also to the first cache memory unit 13. Data of the high-speed readable second cache memory unit 14 is transferred first to the read requester, and then data of the first cache memory unit 13 is transferred thereto. If it is found that there is word data present, not in the memory area m2, but in the first cache memory unit 13, access is made to the first cache memory unit 13,

3) Parallel accessing to the memory areas m1 to m3 of the second cache memory unit 14. In this method, access is made in parallel to tags of the memory areas m1 to m3 and to word data of the memory area m2. If there is word data, it is read and transferred. Thereafter, access is made to the first cache memory unit 13 to transfer line data. If there is no word data present in the memory area m2, and if it is found that there is target data exited in the first cache memory unit 13 according to the tag of the memory area m1, access is made to the first cache memory unit 13.

In the above reading process, even if there is word data present in the second cache memory unit 14, access is made to the first cache memory unit 13 to read line data. However, not to limited to this, for example, if the read requester is requesting word data only, access may not be made to the first cache memory unit 13.

Next, a process of writing to the L2-cache 7 according to the present embodiment will be explained. The write requester makes a write request per line. If there is a hit in the first cache memory unit 13, writing is performed as follows. Firstly, writing is performed to the first cache memory unit 13. Simultaneously with this and as required, access is made to the memory area 3 of the second cache memory unit 14 to perform writing to word data stored in the second cache memory unit 14.

When the write requester makes a write request per word, or even when the write request is made per line and the cache controller identifies a rewritten word in a line, the following options are also possible. For such cases, there are two writing methods when there is a cache hit with tags of the memory areas m1 and m3 of the second cache memory unit 14, as follows.

1) When word data of an address at which writing is to be performed is present in the memory area m2 of the second cache memory unit 14, the word data of the memory area m2 is overwritten and also written in the first cache memory unit 13,

2) When word data of an address at which writing is to be performed is present in the memory area m2 of the second cache memory unit 14, the word data of the memory area m2 is overwritten but not written in the first cache memory unit 13.

In the case of the above 2), no current data is written in the first cache memory unit 13. Therefore, in order that old data is not written back to the lower-layer cache memory 1 or the main memory 8, a dirty flag is required for each word data in the memory area m2. For example, the dirty flag is stored in the memory area m2. When writing back to the lower-layer cache memory 1 or the main memory 8, it is required to merge each dirty word data in the memory area m2 and cache line data in the first cache memory unit 13. Therefore, at the time of writing back, it is required to check based on the dirty flag whether there is word data which is required to be written back to the memory area m2.

Next, a process of LRU replacement will be explained. It is supposed that, based on an LRU position, word data of the first cache memory unit 13 is copied or moved to the memory area m2 of the second cache memory unit 14. In this case, the LRU replacement can be performed only by updating tag information of the memory areas m1 and m2 of the first cache memory unit 13, as long as the number of word data to be copied or moved is the same for each way of the first cache memory unit 13. In general, it is only enough to rewrite an LRU-order memory area associated with each entry. For example, in the case of FIG. 4, it is only enough to rewrite information such as way 0 and way 8 associated with the respective entries.

On the contrary, as shown in FIG. 8, when the number of word data to be copied or moved is different for each way, in addition to general control of the cache memory 1, the following process is required.

1) It is supposed that data is moved from a way of the first cache memory unit 13, which has a smaller number of word data to be copied or moved, to a way which has a larger number of word data to be copied or moved. In this case, word data, the number of which is newly copiable or movable, are copied or moved from the first cache memory unit 13 or the second cache memory 14 to the memory area m2 of the second cache memory unit 14.

2) It is supposed that data is moved from a way of the first cache memory unit 13, which has a larger number of word data to be copied or moved, to a way which has a smaller number of word data to be copied or moved. In this case, only word data of higher priority, among a plurality of word data already copied or moved, is copied or moved to the memory area m2 of the second cache memory unit 14.

It is inefficient to rewrite the entire memory area m2 of the second cache memory unit 14 whenever the LRU positional replacement occurs. Word data may be updated only for the difference between the numbers of word data to be stored in the memory area m2. It is supposed that the number of word data stored in the memory area m2 of the second cache memory unit 14 is two for the way 1 in which data A has been stored and one for the way 8 in which data B has been stored. In this case, for the LRU positional replacement between the ways 1 and 8, the following process can be performed.

Firstly, like a general cache memory 1, tag information is updated to reallocate the area for one word data of the memory area m2, which corresponds to the data A, as the area for one word data of the data B. Then, the one word data of the data B is written in the area for one word data, which is newly allocated to the data B.

As described above, in the present embodiment, apart from the first cache memory unit 13 for storing data per cache line, the second cache memory unit 14 for storing data per word is provided. Therefore, for example, by storing word data, which is accessed first more often in a line, in the second cache memory unit 14, it is achieved to improve an average access speed to the cache memory 1 and also to improve access efficiency because of data access per word, thereby reducing power consumption.

### (Power Cut-Off Method in Present Embodiment)

What has been explained in the above embodiment is high-speed and low-power-consuming access to the cache memory 1 (while being active). Power may also be lowered or cut off when access to the cache memory 1 is rare (while waiting), for power leakage reduction. The state in which power-supply voltage reduction or power cut-off is being performed is referred to as a standby state and the other states are referred to as an active state. The power cut-off in the present embodiment depends on the control policies explained in the embodiment in the active state. Hereinafter, it will be explained with respect to FIG. 5 that the cache controller 15 performs a power-cut process to the first cache memory unit 13 and the memory area m2 of the second cache memory unit 14 in the case where 1) the first and second cache memory units 13 and 14 are controlled under the inclusive type policy, and 2) dirty data is present in the second cache memory unit 14.

Although not shown in FIG. 5, it is a precondition in the following explanation that there is, for example, a 1-bit data-validity flag being set in each entry of the memory area m2 of the second cache memory unit 14. The data-validity flag indicates whether data in the memory area m2 of the second cache memory unit 14, corresponding to each entry, is available (valid) data or unavailable (invalid) data, for an arithmetic operation. For example, the data is valid data if the flag is set to 1 whereas the data is invalid data if the flag is set to 0. There are a variety of flag settings. For example, the data-validity flag may be set for each word data in the memory area m2 of the second cache memory unit 14. Or one data-validity flag may be set for the entire second cache memory unit 14.
(Step 1) Dirty data of the second cache memory unit 14 is copied to the first cache memory unit 13 and a dirty flag is reset.
(Step 2) All of the data-validity flags of the second cache memory unit 14 are set to 0.
(Step 3) Power to the memory area m2 of the second cache memory unit 14 is cut off.
(Step 4) Power to the first cache memory unit 13 is cut off.

These steps may not necessarily be sequentially performed. For example, in the case of the standby state after the process is performed up to Step 3, the transition to the active state may be performed without Step 4. In the transition from the standby to the active state, the following process may be performed. Word data may be copied from the first cache memory unit 13 to the second cache memory unit 14 after the memory area m3 of the second cache memory unit 14 is accessed, as required. Or word data may be copied to the second cache memory unit 14 whenever access is made to the first cache memory unit 13.

For example, in the case of using MRAMs and SRAMs for the first and second cache memory units 13 and 14, respectively, the SRAMs are a main factor of power leakage. In the present embodiment, by performing the process up to Step 3, power leakage from the entire cache can be drastically reduced. Moreover, even after Steps 3 and 4 are finished, since line data has been stored in the first cache memory unit 13, it is restricted that performance is reduced due to data loss in the cache memory units after the active state recovery. Accordingly, according to the present embodiment, a remarkable power leakage reduction effect is achieved while performance reduction due to data loss is restricted.

### (Error Correction Method in Present Embodiment)

There is a problem for the first cache memory unit 13 if it uses MRAMs that bit errors occur more often than in the case of using SRAMs only. In order to solve the problem, for example, as shown in FIG. 2, the error corrector 16 is provided to correct errors of the first cache memory unit 13. However, error correction is performed to each of a plurality of data after each data is read, which causes latency increase in the first cache memory unit 13.

In the present invention, critical word that is used first more often by the arithmetic units 11 is stored in an SRAM of the second cache memory unit 14. Since SRAMs do not require error correction in general, word data can be transferred to the read requester prior to reading and error correction to the second cache memory unit 14. The arithmetic units 11 can perform arithmetic operations to data required at present if the data is word data transferred in advance, without waiting for line data of the first cache memory unit 13. In this way, according to the present embodiment, performance reduction due to error correction overhead can also be restricted.

Although several embodiments of the present invention have been explained above, these embodiments are examples and not to limit the scope of the invention. These new embodiments can be carried out in various forms, with various omissions, replacements and modifications, without departing from the conceptual idea and gist of the present invention. The embodiments and their modifications are included in the scope and gist of the present invention and also in the inventions defined in the accompanying claims and their equivalents.

1. A cache memory comprising:
a first cache memory that is accessible per cache line; and
a second cache memory that is accessible per word, the second cache memory being positioned in a same cache layer as the first cache memory.

2. The cache memory of claim 1, wherein the second cache memory is accessible at least one of at a lower access power or at a higher access speed than the first cache memory,

3. The cache memory of claim 1, wherein data stored in the second cache memory is also stored in the first cache memory.

4. The cache memory of claim 1, wherein data to be stored in the second cache memory and data to be stored in the first cache memory are exclusively stored.

5. The cache memory of claim 1, wherein the first cache memory comprises a plurality of ways accessible per cache line,
wherein the plurality of ways are assigned priority levels of at least two,
the second cache memory stores a specific number of word data for a way of the first cache memory, the specific number corresponding to the priority level assigned to the way.

6. The cache memory of claim 5, wherein the second cache memory stores a larger number of word data of a way which is accessed at a higher frequency in the first cache memory.

7. The cache memory of claim 1, wherein the second cache memory stores at least one word data corresponding to a head address in the cache line of the first cache memory.

8. The cache memory of claim 1, wherein the second cache memory stores, in order of access frequency, word data accessed by a processor at a higher frequency among line data stored in the first cache memory.

9. The cache memory of claim 1, wherein the second cache memory stores, in order of access count number, word data accessed by a processor at a higher access count number among line data stored in the first cache memory.

10. The cache memory of claim 1, wherein the second cache memory comprises a first tag which stores address information of data stored in the first cache memory,
wherein an entry of the second cache memory corresponds to an entry of the first tag.

11. The cache memory of claim 10, wherein the second cache memory comprises a second tag which stores identification information for identifying word data stored in the second cache memory.

12. The cache memory of claim 11 further comprising a cache controller to control access to the first and second cache memories,
wherein the cache controller accesses in parallel the first tag, the second tag, and word data in the second cache memory, and accesses the first cache memory if there is a cache hit as a result of access to the first tag.

13. The cache memory of claim 11 further comprising a cache controller to control access to the first and second cache memories,
wherein the cache controller accesses the first tag and the second tag, and based on access information thereof, determines whether to access in parallel word data in the second cache memory and line data in the first cache memory, to access only the line data in the first cache memory, or to access neither the word data nor the line data.

14. The cache memory of claim 11 further comprising a cache controller to control access to the first and second cache memories,
wherein the cache controller accesses in parallel the first tag, the second tag, word data in the second cache memory, and the first cache memory.

15. The cache memory of claim 11 further comprising a cache controller to control access to the first and second cache memories,
wherein, when there are hits in the first tag and the second tag in writing data, the cache controller writes the data in both of the first and second cache memories.

16. The cache memory of claim 11 further comprising a cache controller to control access to the first and second cache memories,
wherein, when there are hits in the first and second tags in data writing, the cache controller does not write first data not yet stored in the first cache memory but overwrites second data already stored in the second cache memory with the first data and stores dirty information in the second tag per word data, the dirty information indicating whether the first data is not yet written back to the first cache memory.

17. A processor system comprising:
a processor; and
a cache memory,
wherein the cache memory comprises:
a first cache memory that is accessible per cache line; and
a second cache memory that is accessible per word, the second cache memory being positioned in a same cache layer as the first cache memory.

18. The processor system of claim 17, wherein the second cache memory is accessible at least one of at a lower access power or at a higher access speed than the first cache memory.

19. The processor system of claim 17, wherein data stored in the second cache memory is also stored in the first cache memory.

20. The processor system of claim 17, wherein data to be stored in the second cache memory and data to be stored in the first cache memory are exclusively stored.
